(19) United States
(12) Patent Application Publication
(10) Pub. No.: US 2003/0187739 A1
(43) Pub. Date: Oct. 2, 2003

(54) System and method of providing an interface to the internet

(76) Inventor: Arthur C. Powers, New York, NY (US)

Correspondence Address: COHEN, PONTANI, LIEBERMAN & PAVANE, Suite 1210, 551 Fifth Avenue, New York, NY, 10176, US

(21) Appl. No.: 10/354,743

(22) Filed: Jan. 30, 2003

Related U.S. Application Data
(63) Continuation-in-part of application No. 09/876,687, filed on Jun. 7, 2001.

(51) Int. Cl. G06F 17/60

(52) U.S. Cl. 705/14

(57) ABSTRACT

A system and method is disclosed in which a distributor system acts as an intermediary between a portal application on a user's computer and the Internet. In one aspect of the present invention, the distributor system acts as a shield between the Internet and the user, thus protecting the privacy and identifying data of the user. In another aspect, the distributor system provides copyrighted digital material to the user while also paying appropriate royalties to the copyright owner. In yet another aspect, the distributor system provides a computing community for the user by establishing the user as a member of an affinity group.

### RELATED APPLICATIONS

This is a continuation-in-part of U.S. patent application Ser. No. 09/876,687 filed Jun. 7, 2001, and entitled “Method of Direct Customers”, which is herein incorporated in its entirety. In addition, this application claims priority from U.S. Provisional Patent Application Serial No. 60/353,105 filed on Jan. 30, 2002 and U.S. Provisional Patent Application Serial No. 60/367,519 filed on Apr. 30, 2002, both of which are incorporated herein in their entirety.

### BACKGROUND OF THE INVENTION

1. Field of the Invention

This invention relates to a system and method of communication between a business, a user or potential customer, and a distributor of information positioned between the first two.

2. Description of the Related Art

With the rapid growth of the Internet, people are now able to access large amounts of information from their home computers. Although the Internet in some ways is a good venue for providing advertising and other branding and/or marketing information to the public, there are various pitfalls for both user/consumers and vendors/businesses in its widespread use.

For consumers/users, there are fears concerning the loss of privacy that Internet businesses often require when accessing information or ordering products. People searching for product information on the Internet desire their identity to be protected, so that their mere searching may not result in a company obtaining data about them. There are no current means for the technically unskilled to effectively and completely hide their identity when they access a website with a query.

For vendors/businesses, there is the inability to appropriately target advertising information. On the one hand, for advertising targeting systems to truly target individual user/consumers, they require the vendors/businesses to retain more information about user/consumers than user/consumers are comfortable with. On the other hand, without such information, the advertising can not be adequately targeted.

For vendors/businesses which own copyrighted digital material, there is the inability to protect such copyrighted digital material from illicit copying, reproduction, and transmission. The remarkable advances in the efficiency and ease of digitally storing and reproducing artistic works (e.g., photographs and musical pieces) combined with the feeling of many personal computer users that material downloaded from the Internet is (or at least should be) free, have allowed for the widespread dissemination of copyrighted material without royalties being paid to the copyright owner.

In some instances of copyright infringement on the Internet, a centralized organization, such as the now-inactive Napster, provides the ability for users to download copyrighted musical material (in Napster's case, from other users). Having been sued by the recording industry for contributing to copyright infringement, Napster has been forced to stop this practice. In Napster's place, decentralized systems (e.g., peer-to-peer networks), such as Gnutella, have sprung up. In these decentralized systems, music files can be shared freely and directly among Internet users without relying upon a centralized server for storing the musical files. Thus, the illicit copying of copyrighted musical works can continue, but, without a single entity committing the infringement, a copyright owner would need to sue hundreds (if not thousands) of individuals in order to recoup lost royalties.

Furthermore, for Internet users in general, it is difficult to create a sense of community, or shared experience, from one's interaction with the Internet. Although there are services such as instant messenger, chat room, and/or web log (“blog”), these services are discrete functions that the user must either join or sign onto. The overall Internet interaction of the user is not communal, not shared.

Therefore, there is a need for a system and method for providing interaction with the Internet that allows for the targeted distribution of advertising, marketing, and/or branding data, and the ability for a user to browse and search, without sacrificing the personal privacy of the user. Furthermore, there is a need for a system and method that allows for users to easily download digital artistic works, such as music files, while still providing protection to the copyright holders. Lastly, there is a need for a system and method for providing a communal experience for users of the Internet, as well as identity within a larger affinity group.

### SUMMARY OF THE INVENTION

It is an object of the present invention to provide a system and method for targeted distribution of advertising, marketing, and branding data, while providing privacy for individual users

It is another object of the present invention to provide a system and method for a user to download copyrighted digital material without infringing the rights of the copyright owner(s).

It is yet another object of the present invention to provide a system and method for providing community and group identity with a user's overall computing experience.

These and other objects are accomplished by the present invention, which provides for privacy protection, shielded queries, copyright protection, and affinity grouping. In one aspect of the present invention, a distributor positioned conceptually between the company and user or searcher supplies a “blind” between the user or searcher and company so that the searcher may obtain information with the knowledge that no identity data is being shared with the company. Furthermore, companies may solicit users through the distributor in a non-threatening manner, since the receiving user can safely find out more about the solicitation without giving out identity data. In the quest to further strengthen brand recognition and customer loyalty, many schemes have been suggested.

In another aspect of the present invention, the distributor is positioned conceptually between a digital content provider and the end user, as well as between advertisers and the end user. The distributor receives digital content from the music content provider and allows end users to download the digital content, while tracking the number of downloads and the personal tastes of the end users. Advertisers target advertising to end users that fit a particular profile, such as those that appear to enjoy (because they download) a particular type of digital content. The distributor reaps the profits from the targeted advertisements, and pays the royalties to the copyright owners based on number of downloads. Furthermore, after a period of time, an end user may select a number of downloaded digital pieces to be copied onto a personalized compact disk (CD).

In another aspect of the present invention, branding value for an institution and community-building for an affinity group are provided in a user's overall computing experience. According to one embodiment, a set of portal applications are modified to be identified with the brand of an institution and are distributed to a particular affinity group associated with the institution. When using the portal application, the brand of the institution is presented and the sense of community for the members of the affinity group is reinforced.

According to another aspect of the invention, portal applications are distributed by any means to a plurality of people including at least one affinity group associated with an institution. When one first sets up or uses the portal application, one is given the choice to select to be associated with at least one affinity group or institution (or none at all). If a user selects at least one affinity group and/or institution, the Distributor will modify the user's portal application in a manner appropriate to the selected affinity group and/or institution.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a block diagram of a system of portal applications installed on end user's PCs and having communication links with a Distributor;

FIG. 2 is a flowchart of a method for a user to retrieve data according to one aspect of a preferred embodiment of the present invention;

FIG. 3 is a block diagram of the operative elements in a system and method for end users to download copyrighted digital material according to a preferred embodiment of the present invention;

FIG. 4 is a block diagram of the operative elements in a distributor according to a preferred embodiment of the present invention; and

FIG. 5 is a block diagram of a system of portal applications installed on end user's PCs and having communication links with a Distributor, where certain end users are members of one or another affinity group according to a preferred embodiment of the present invention.

### DETAILED DESCRIPTION OF THE PRESENTLY PREFERRED EMBODIMENTS

In order to describe the present invention, the invention in parent U. S. patent application Ser. No. 09/876,687 (the ′687 application), which has been incorporated by reference, will be used as a foundation. However, the system in the ′687 application is only used herein as an illustrative system in which the present invention could work. It is possible other portal systems could be used in accordance with the present invention.

According to the system in the ′687 application, there are End Users (i.e., consumer/users) and a Distributor. The Distributor maintains a “portal” on the End Users' personal computers (PCs) which provides useful programs (such as a web browser, a calendar/organizer, a search function, a word processor, etc.) to the End User. The portal is the End Users' gateway to the Internet and to much of the functionality of the PC. While functioning as a gateway, the portal may present directed advertisements and other information to the End User PC.

The portal application may be distributed to the End Users through a multitude of means. The portal application may be, for example, downloaded from the Internet, received in a mass mailing (in CD form), picked up at a retail store, or received in a targeted mailing.

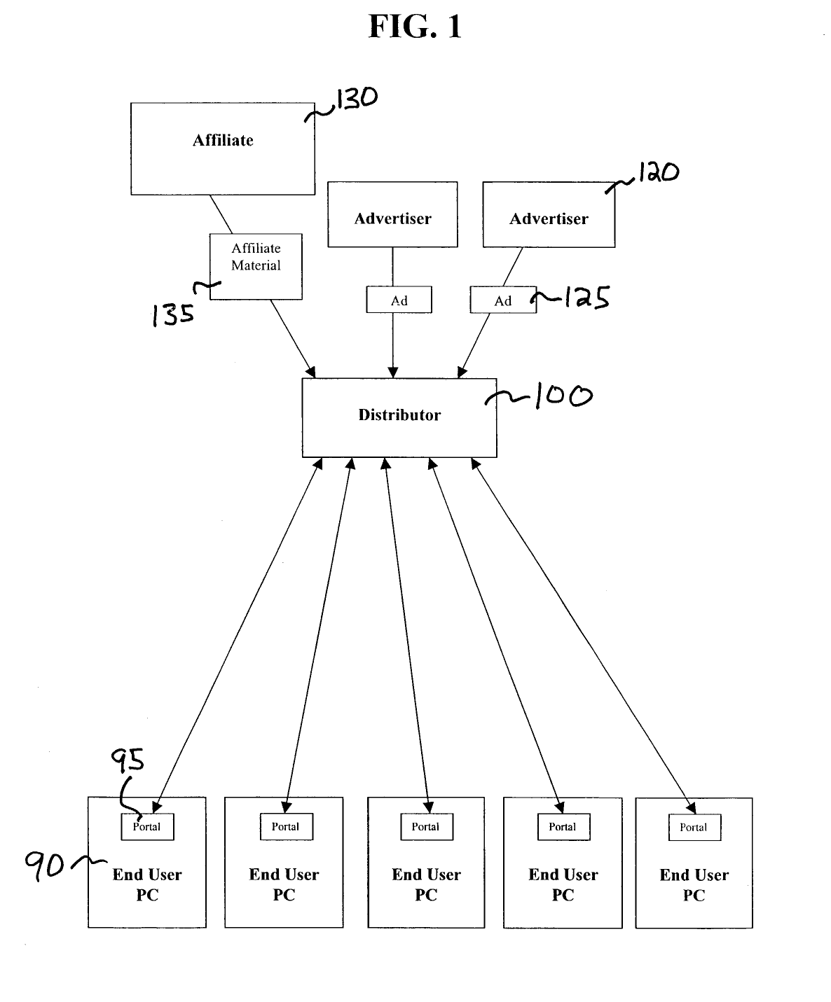

As shown in FIG. 1, the Distributor 100 maintains communication links with each of the portal applications 95 in the End Users' PCs 90. These links may be over the Internet, on a private network, direct point-to-point connections, etc. In addition, the Distributor 100 has communication links with Advertisers 120, who provide ads 125 to be shown in the portal applications of End Users, and Affiliates 130, who may provide affiliate material 135, including content information as well as advertisements. The links between the Distributor 100 and End Users 90 and/or between the Distributor 100 and advertisers 120 and/or affiliates 130 may be constantly or intermittently maintained.

Privacy Protection & Shielded Queries

The Distributor 100 maintains database records concerning the End Users 90, and, preferably, these database records are kept private and confidential, so that no third parties (including advertisers 120 or affiliates 130) may access the database records. These database records may track the individual interests of the End Users 90 (as shown by their interaction with the portal), as well as register preferences that the End Users 90 themselves enter into portal 95 for storage. These registered interests and preferences may be used to target advertisements 125 from advertisers 120. It is also contemplated that the Distributor 100 may not be able to access parts of the database records in order to insure privacy.

The Distributor 100 may act as the End Users' 90 agent, by querying other web sites on the Internet in order to mine information, but “shielding” the End Users 90 by not letting any End User 90 personal information out onto the Internet. By these means, the Distributor 100 may provide advertisers 120 and/or affiliates 130 with statistical data and marketing analysis concerning either End Users that are shoppers or have shown an interest relevant to advertisers 120 and/or affiliates 130 during browsing, while simultaneously shielding the End Users' 90 personal information from advertisers 120.

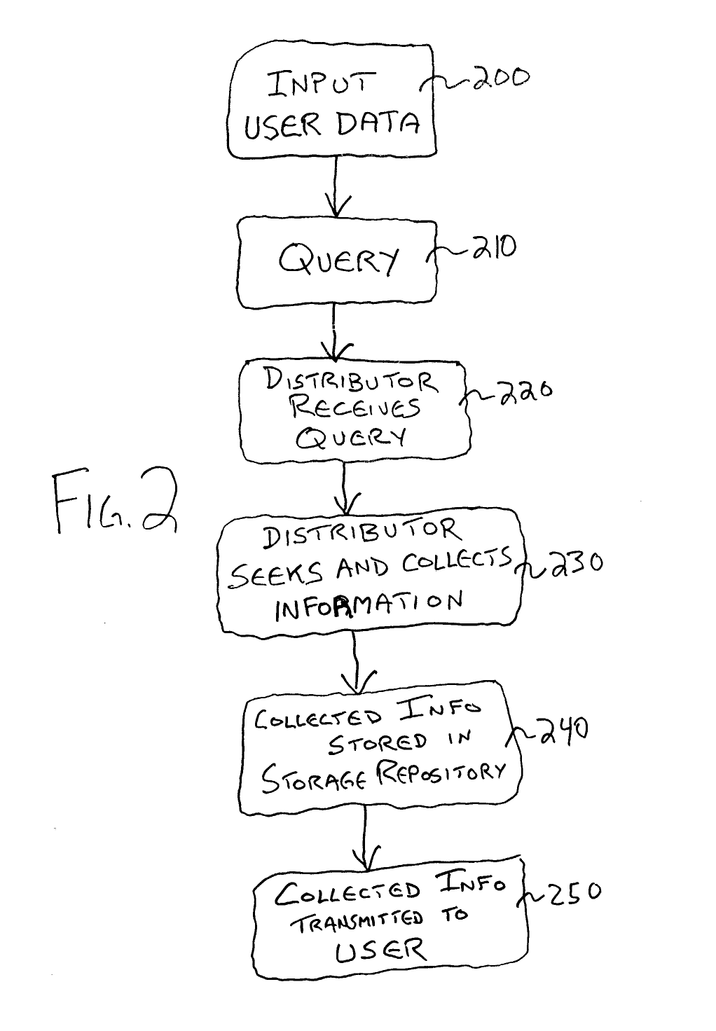

In one aspect of the present invention, Distributor 100 receives queries from users and solicits information from companies in order to respond to the queries. As shown in FIG. 2, data is input in step 200 by a user into database records maintained by the Distributor 100. It is contemplated that the database used in the present invention can be either hierarchical or relational: either way, the information contained in the database records may be easily sorted and/or searched using any index or characteristic. In a preferred embodiment, the database record for a user may be seen as comprising a table (or multiple tables) with columns and rows. The columns are specifically identified and named. The tables enable a user to make easy, facile employment of the columns to categorize and label personal interests, of a user, by column. Columns may be identified and tagged by text description, by controls placed on the user interface, or by query. The identification of the columns may be assigned, by any of the distributor, the company, or a user.

In step 210 in FIG. 2, the user sends out a query. The query may be an Internet search for specific information about a product or service, or a search for general information on a topic, or even a specific query to website or server. Distributor 100 receives this query in step 220 and, in step 230, seeks out and collects information, e.g., by mining the information directly from information sources or by searching the Internet for such information, in response to the query from the user. After retrieval, Distributor 100 stores the retrieved information in a storage repository which is controlled by Distributor 100, in step 240. In the preferred embodiment, the storage repository does not store any information correlating the source of the data and the user who made the initial query.

In step 250, the retrieved data is delivered to, and displayed for, the user. In the preferred embodiment, the retrieved data is written to the appropriate column and row of the database record, and so becomes part of the stored user information. It is also possible that only a pointer to the appropriate location for the retrieved data in the storage repository, or a summary of the retrieved data, or a codeword representing the retrieved data is stored in the database table.

In this manner, the user can make queries that are shielded from other entities obtaining and storing information about the user. The system is also capable of delivering retrieved information to the user, even without a query. In such a situation, Distributor 100 determines, based on the user's database record, that the user may be interested in a certain subject, topic, issue, product, and/or service, and then transmits such data to the user. The author of any retrieved information, whether a retail company or any other information source, can not identify the user that either requests or receives information. Although the user is shielded from other entities, Distributor 100 is still capable of providing information services on behalf of other entities, as well as analyzing and reporting statistical information and user responses to a particular advertisement or other transmitted data.

FIG. 2 is an exemplary embodiment, and is not meant to limit this aspect of the invention to those steps, or that order of steps. The essence of the invention is the establishment of a “blind” (or distributor) between the user and a company from which the user may wish to obtain information. The distributor may take a myriad of forms (including, but not limited to, those described in the ′687 application mentioned above), and the functionality of the distributor may be placed anywhere.

Copyright Protection

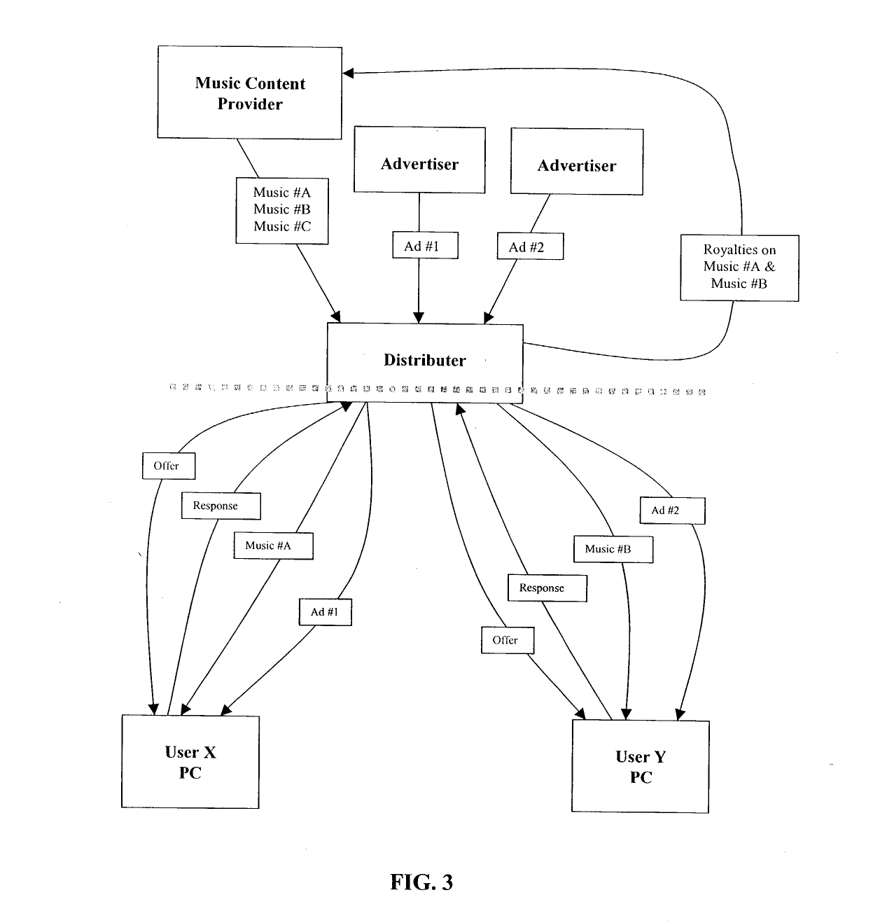

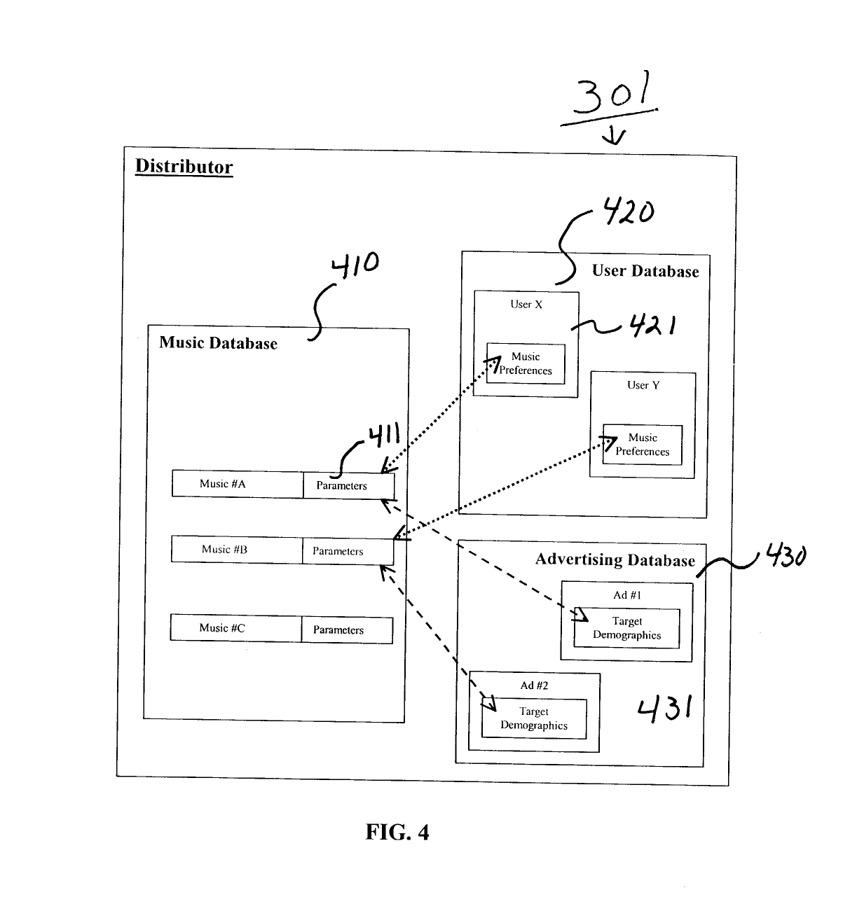

In FIGS. 3 & 4, another aspect of the present invention is shown, in which users can download copyrighted digital material while copyright protection is still guaranteed. FIG. 3 is a block diagram showing the different entities involved in the system, as well as the various transfers of information and resources performed by those entities according to the preferred embodiment of the present invention. FIG. 4 is a block diagram showing the conceptual operative elements in the Distributor according to the preferred embodiment of the present invention.

In the embodiment shown in FIGS. 3 & 4, the copyrighted digital material is music, but this is only to illustrate this aspect of the present invention; the present invention may be used with any copyrighted digital work.

In FIG. 3, Distributor 301 receives various pieces of music (“Music #A”, “Music #B”, etc.) from Music Content Provider 305. Dotted line 350 represents the “shield” maintained by Distributor 301 between the Advertisers 310 and the End Users. Possible entities which may act as Music Content Provider 305 include, but are not limited to, music studios or labels, or a radio station. If Music Content Provider 305 is a radio station, it may be acting as both a Music Content Provider 305 and an Advertiser 310, or perhaps as an Affiliate of the Distributor 301 (the concept of “affiliate” is defined in the ′687 application).

In such a situation, Distributor 301 may be acting as an “Internet radio station” on behalf of the radio station, and thus Distributor 301 would be responsible for performance rights royalties (assuming the music is provided in a streaming format). Performance right royalties are distinguishable from reproduction and distribution royalties: Distributor 301 is liable for reproduction and distribution royalties when Distributor 301 uploads a piece of music to an End User's PC for playing at a later time, whereas Distributor 301 is liable for performance right royalties when the digital data comprising a piece of music is being streamed to an End User's PC for near-simultaneous “playing”. The End User may play a downloaded piece of music at any time, but a streaming piece of music may play only during its webcast (i.e., broadcasting over the Internet), if not downloaded at the same time as the webcast.

Presently, royalties for performance rights are collected by performance rights societies, such as ASCAP (American Society of Composers, Authors, and Publishers) and BMI (Broadcast Music, Inc.). For instance, ASCAP charges a radio or television station a flat fee for using any musical piece in ASCAP's repertory (which includes over three million compositions), without regard to how many pieces are broadcast or how often a particular piece is broadcasted. In an embodiment of the present invention in which music broadcast from a radio station is simultaneously streamed to the End Users' PCs, Distributor 301 could pay the fees to ASCAP, BMI, and other performing rights societies. In this way, the radio station obtains a larger audience for their own material without having to pay the additional fees.

Returning to FIG. 3, three pieces of music (Music #A, Music #B, and Music #C) are downloaded from Music Content Provider 305 to Distributor 301. As shown in FIG. 4, Music #A, Music #B, and Music #C are stored in Music Database 410 along with certain descriptive Parameters 411, such as type of music, performer(s) of the piece, composer(s) of the piece, timelength, size of music file, etc. In one embodiment of the present invention, Distributor 301 matches one or more characteristics from the Parameters 411 of individual musical pieces with one or more characteristics stored in End User's Records 421 in User Database 420. For example, if it is a country/western song, it may be matched up with the record of an End User who enjoys country/western music. The user may have intentionally added these music-matching characteristics to his or her own record, or these music-matching characteristics might be entered automatically by Distributor 301 if Distributor 301 notices a pattern that indicates a music preference (e.g., if a particular user has downloaded a number of country/western songs, a musical preference for country/western music may be entered in the user's record).

In addition, Distributor 301 matches one or more characteristics from the Parameters 411 of individual musical pieces with one or more characteristics stored in Ad Records 431 in Ad Database 430. For example, an advertisement for acne cream might indicate that its target audience is teenagers—if a downloaded song is a teenage pop song, it will be matched up with the record of the advertisement concerning acne cream. The advertiser may have intentionally added these music-matching characteristics to their ad record, or these music-matching characteristics might be entered automatically by Distributor 301 if Distributor 301 notices a pattern that indicates a music preference (e.g., if a number of users who have downloaded a country/western songs have also ordered cowboy boots on-line, a musical preference for country/western music may be entered in an ad record concerning cowboy boots).

Having found one or more users whose musical preference matches the music downloaded from Music Content Provider 305, Distributor 301 directs the portals on the PCs of individual users to offer the respective matching songs. For instance, after matching Music #A with the musical preferences of User X, Distributor 301 directs the portal in User X's PC 320 to show a download offer to User X (321). Such an offer may take the form of a pop-up box or may appear in one of the panes of the portal itself, or may arrive as an e-mail, etc. If User X responds positively (322), the piece of music (i.e., Music #A) is downloaded to User X's PC (323) as well as Ad#1 (324). In other embodiments, the music piece is not downloaded to the End User's PC, but stored at the Distributor and referred to by the End User's record in User Database 420. Meanwhile, as shown in FIG. 4, Distributor 301 tracks the number of downloads of each particular piece of music and stores that information in the parameters of the database record of that piece of music.

In the preferred embodiment, Distributor 301 uses the revenues from the advertisements to pay the copyright royalties to Music Content Provider 305 (316). If Distributor 301 is acting as an Internet radio station, the steps would be different than shown in FIG. 3. However, if musical pieces are being continually streamed to the end users' PCs, the portal could display an offer for the end user to download the piece currently “playing” (or for any of the past songs that have played).

In addition, after a period of time (e.g., a week) the Distributor may offer the End User a personalized compact disk (CD) consisting of all the music pieces the End User has downloaded. This could be done for free, or for a fee. It is also contemplated that pieces of music downloaded to the End User's PC may be structured so that it is normally not possible for the End User to burn their own copy. In this case, the Distributor may offer the End User the opportunity to create (e.g., ‘burn’) a copy by temporarily removing the preventative measures on copying downloaded copies.

In one preferred embodiment, user X performs a “daily download” from Distributor 301. This daily download may comprise a number of items selected either by Distributor 301 or pre-selected by user X, such as one or more musical pieces, one or more news items, one or more advertisements, one or more answers to queries, etc. The musical pieces in the daily download may be stored, for example, either on X user's PC 320 or by providing a pointer in User X's Database Record 421 to the musical piece's storage position in Music Database 410. User X's ability to access the musical piece may be time-limited; in other words, User X would only be able to play the musical piece for that day, or the following week, etc. At the end of this period of free access, User X may be offered the ability to further access the musical piece in exchange for something, such as money, or User X's time in terms of filling out a questionnaire or watching/listening/responding to an advertisement. There could also be a negotiation between User X and the Music Content Provider 305 for access rights. In addition, these access rights may be limited in duration, e.g., a week's ability to play the piece on User X's PC 320.

FIGS. 3 and 4 are exemplary drawings, and are not meant to limit the invention to those steps or those functional modules, or that order of steps. Although discussed as the functional modules in FIG. 3 are shown as separate databases, they may comprise a single database or a plurality of distributed databases. The Distributor may take a myriad of forms (including, but not limited to, that described in the '687 application mentioned above), and the functionality of the Distributor may be placed anywhere (e.g. a mainframe computer) or distributed throughout an entire networked system of computing devices.

Affinity Groups and Lateral Instant Messaging

According to another aspect of the invention, a set of portal applications are modified to be identified with the brand of an institution and/or affinity group. Exemplary modifications to the portal applications include having one or more panes of the portal application GUI window show at least one of: the brand of an institution, the latest news about or from an institution and/or affinity group, or other information appropriate for that affinity group. These modified portal applications may be embodied on CD-ROMs.

These modified portal applications are distributed to the particular affinity group associated with the institution. For example, a college or university may mail out the modified portal applications to alumni, or possibly provide them at an alumni event, such as homecoming. As another example, a charitable institution may distribute the modified portal applications to donors or potential donors. As yet another example, a religious institution may provide a stack of CD-ROMs containing the modified portal application in a publicly accessible section of a house of worship. It is also possible that individuals may download the modified portal application from a website maintained by the institution and/or affinity group.

Whether distributed on a computer-readable medium or downloaded over a communication link, the modified portal applications according to this aspect of the invention have some form of identifying indicia so that the Distributor will recognize that the user of the modified portal application is a member of a particular institution and/or affinity group. Such indicia may be stored by the Distributor in an appropriate database table at the time of first contact with the user's installed portal application. Thus, the Distributor will know which portal applications to send particular institution and/or affinity group information.

When using the portal application, the brand of the institution is presented and members of the affinity group are reinforced in their sense of community. As an example, the diary screen of the portal application may automatically present information concerning the institution and/or affinity group, such as upcoming events of a particular alumni chapter to which the user belongs. As another example, a small logo or brand of the institution and/or affinity group may appear in a section of each screen of the portal application (this could also operate as a hyperlink to the institution and/or affinity group's website, to recent messages from the institution and/or affinity group, or to an Instant Messaging application, as described below, etc.).

Because the portal application is free, provides many useful computing, Internet, and life management tools (such as search engine, browsing capability, appointment book, etc.), as well as providing security from spam and the tracking capabilities of third parties (through the intervening shield of the Distributor), the user keeps using the portal application. Furthermore, because of the identification between the portal application and the institution and/or affinity group, the good will generated by usage of the portal application is shared by the institution and/or affinity group.

According to another aspect of the invention, portal applications are distributed by any means to a plurality of people including at least one affinity group associated with an institution. In other words, according to this aspect, the institution and/or affinity group does not take responsibility for distributing the portal application. The portal application is a generalized portal application for usage by any and all users, and may be distributed by any and all means (e.g., by mass mailings, by distribution in newspapers and other periodicals, by maintaining stacks of CD-ROMs in publicly accessible places, such as retail stores, etc.). This means that the modifications needed to tailor the portal application to an institution and/or affinity group are either latent (but inactive) in the generalized portal application, or are somehow added on to the generalized portal application. In a presently preferred embodiment, the modifications are one of 1) built in to the general portal application but inactive until activated by the user or Distributor; 2) downloaded from the Distributor (or the institution and/or affinity group) by means of the portal application itself.

According to this aspect of the present invention, when a user first sets up or uses the portal application, the user is given the choice to select, or to be associated with, at least one affinity group or institution (or none at all). If a user selects at least one affinity group and/or institution, either the latent modifications in the user's portal application are activated, or the Distributor will modify the user's portal application in a manner appropriate to the selected affinity group and/or institution.

In another embodiment, the user may be offered at a later time by the Distributor to join an affinity group and/or be associated with an institution because the Distributor has determined that the user is either interested in or associated with the group and/or institution. This determination could be made by the Distributor analyzing the user's interests and/or personal information, or because the institution and/or affinity group has entered into a contractual relationship with the Distributor.

Preferably, the user may choose whether or not to select the institution and/or affinity group, and, if the user chooses not to be associated with the institution and/or affinity group, the records and identity of the user would not be released to the institution and/or affinity group. It is also possible that, even if the user chooses an institution and/or affinity group, the Distributor will shield the user's identity and records from the institution and/or affinity group. By these means, the institution and/or affinity group obtains the exposure they require, while the individual users retain the anonymity they desire. It is also contemplated that the user is given the option either to have their identity shielded from, or known by, the institution and/or affinity group.

In another embodiment, the Distributor does not make the offer to the user, but the user encounters the offer him- or herself. For example, the user may encounter an offer to be part of an alumni group (i.e., to have the appropriate modifications made to their portal application) while at the website of an educational institution. It is contemplated that such offers could be made over any media, e.g. an alumni magazine may list the steps to take if one wishes to modify their portal application to become a member of the alumni affinity group.

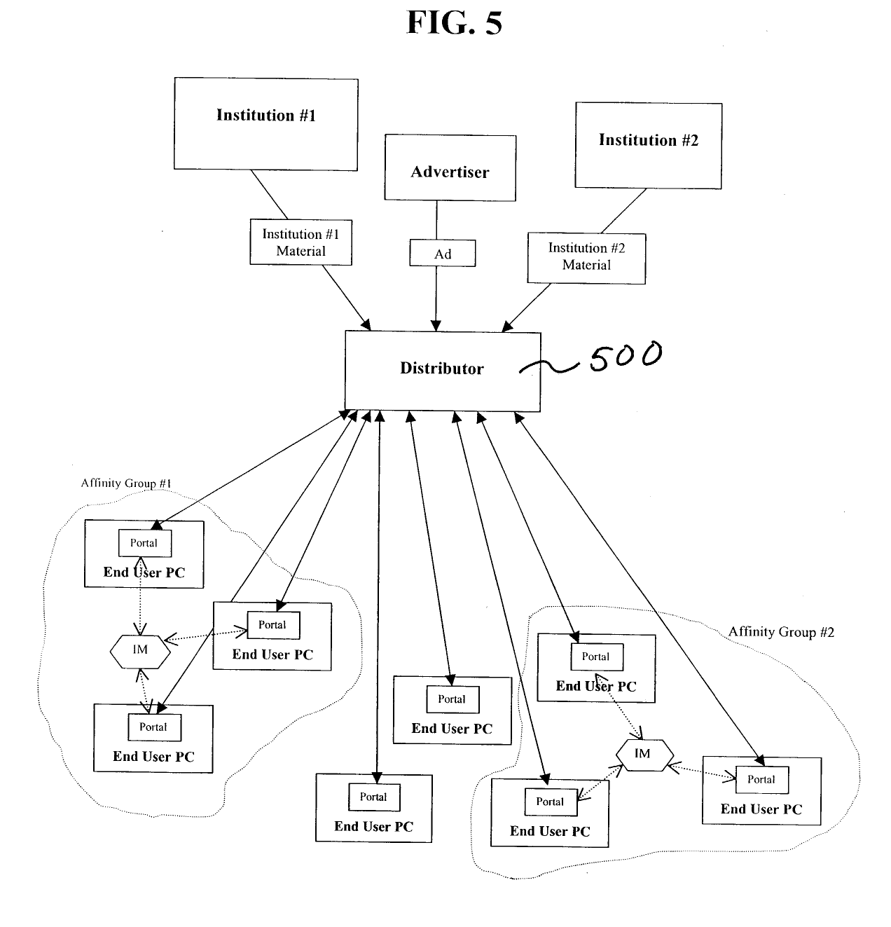

FIG. 5 shows a system according to either aspect of a preferred embodiment of the present invention. In this drawing, Affinity Group #1 is associated with Institution #1, and Affinity Group #2 is associated with Institution #2, although it is not necessary that an affinity group be associated with a particular institution. As shown in FIG. 5, there are many End Users with portals installed on their PCs, but some of the End Users are also members of an affinity group. Materials from the appropriate institution are sent to the portals of the members of the appropriate affinity group. It is contemplated that a user may be associated with more than one affinity group and/or institution, in which case the portal application will need to be modified in such a manner as to allow the user to receive the appropriate information for the two or more affinity groups. In these cases, the user may need to choose a primary affinity group which will appear in selected screens and/or panes of the portal application, and/or certain screens and/or panes of the portal application may cycle between information concerning different affinity groups.

FIG. 5 shows that, in the preferred embodiment of the present invention, the Distributor 500 is operating as the intermediary between the institutions and the affinity groups. In this manner, the user may be free to join and/or leave an affinity group without fear of being on a list maintained by an institution or third party. Although not preferable, it is also possible that the institutions also have a list of the users in their associated affinity group.

FIG. 5 also shows another feature of the affinity groups according to the present invention. The IM polygon in the middle of each affinity group represents an Instant Messaging capability between the various end user members of an affinity group. Thus, members of an affinity group can tell if other members of their affinity group are on-line, without the user necessarily listing all of the members of the affinity group in the IM service. It is also contemplated that the end user may block out one or more IM “buddies” within the affinity group if the user wishes to. The IM service further serves to reinforce the sense of community amongst affinity group members.

The IM service may appear in a designated pane within a window of the portal application where the user may see the communications occurring between on-line members, or the user may select an icon which causes the IM service to pop up in its own window. In addition, the user may indicate certain topics he or she wishes to discuss, and the IM service may remain dormant until some sort of communication is made concerning that topic. At that point, a flashing icon might appear, or the IM service window may pop up, etc.

While there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for providing a secure interface between the Internet and a user, comprising the steps of:
providing a portal application to a user, wherein said portal application comprises a graphical user interface (GUI), user productivity utilities, and network access utilities;
installing the portal application in a computing device of the user;
establishing a connection between the portal application and a distributor system;
generating, by the user, a query in the portal application;
transmitting the query to the distributor system;
retrieving, by the distributor system, data from at least one data source connected to the Internet based on the received query;
storing, by the distributor system, the retrieved data in a storage repository;
storing, by the distributor system, at least one of an indicia of the retrieved data or the retrieved data in a user database record of the user; and
transmitting the retrieved data to the user for presentation;
wherein there is no correlation in the storage repository between the retrieved data and the user whose query resulted in the retrieved data; and
wherein the distributor system has the capability of using the at least one of an indicia of the retrieved data or the retrieved data stored in the user database record to target information relating to the retrieved data to the user.

2. A system for providing a secure interface between the Internet and a user, comprising:
a distributor system for receiving a query from a portal application installed in a computing device of the user, for retrieving data from at least one data source connected to the Internet based on the received query, for storing the retrieved data in a storage repository, for storing at least one of an indicia of the retrieved data or the retrieved data in a user database record of the user, transmitting the retrieved data to the portal application for presentation to the user;
wherein there is no correlation in the storage repository between the retrieved data and the user whose query resulted in the retrieved data;
wherein the distributor system can use the at least one of an indicia of the retrieved data or the retrieved data stored in the user database record to target the transmission of information relating to the retrieved data to the user.

3. A method for providing copyrighted digital material to a user, comprising the steps of:
providing a portal application to a user, wherein said portal application comprises a graphical user interface (GUI), user productivity utilities, and network access utilities;
installing the portal application in a computing device of the user;
establishing a connection between the portal application and a distributor system;
receiving, by the distributor system, copyrighted digital material;
storing, by the distributor system, the copyrighted digital material and descriptive parameters concerning the copyrighted digital material;
receiving, by the distributor system, a request from the portal application for the copyrighted digital material;
transmitting, by the distributor system, the copyrighted digital material to the portal application of the user for presentation to the user;
matching, by the distributor system, the descriptive parameters concerning the copyrighted digital material with advertising parameters associated with an advertisement stored in an advertising database; and
transmitting, by the distributor system, the advertisement associated with the advertising parameters matching the descriptive parameters concerning the copyrighted digital material;
wherein the distributor system maintains a user database containing user parameters concerning copyrighted digital material.

4. A system for providing copyrighted digital material to a user, comprising:
a distributor system for providing copyrighted digital material to a user and for providing royalties to a owner of the copyright in the copyrighted digital material, said distributor system comprising:
a content database containing the copyrighted digital material and descriptive parameters concerning the copyrighted digital material;
a user database containing user parameters concerning digital material content; and
an advertising database containing an advertisement and advertising parameters concerning digital material content;
wherein the user requests the copyrighted digital material and the distributor provides the copyrighted digital material and the advertisement when the advertising parameters match the descriptive parameters concerning the copyrighted digital material; and
wherein the distributor system has the capability of using the user parameters concerning digital material content to identify the user in order to send the user an offer for copyrighted digital material.

5. A method for establishing a user as a member of an affinity group, comprising the steps of:
at least one of:
providing a portal application to a user, wherein said portal application comprises a graphical user interface (GUI), user productivity utilities, network access utilities, and enhancements tailored to an affinity group, wherein the portal application comprises indicia indicating the user is a member of the affinity group; and
installing the portal application in a computing device of the user; or:
modifying a portal application already installed on a computing device of the user, wherein said step of modifying comprises at least one of installing or activating enhancements tailored to an affinity group and indicia indicating the user is a member of the affinity group
establishing a connection between the portal application and a distributor system;
receiving, by the distributor system, information concerning the affinity group;
identifying, by the distributor system, the portal application to which to send the affinity group information by means of the indicia;
transmitting, by the distributor system, the affinity group information to the identified portal application; and
presenting, by the portal application, the received affinity group information to the user.

6. A system for establishing a user as a member of an affinity group comprising:
a portal application for the user, wherein said portal application comprises a graphical user interface (GUI), user productivity utilities, network access utilities, and enhancements tailored to an affinity group, wherein the portal application comprises indicia indicating the user is a member of the affinity group; and
a distributor system for receiving information concerning the affinity group, for identifying the portal application to which to send the affinity group information by means of the indicia, and for transmitting the affinity group information to the identified portal application.

7. The system of claim 6, further comprising:
a means for providing lateral instant messaging between the user and any other users of the affinity group.
